(19) United States
(12) Patent Application Publication
(10) Pub. No.: US 2026/0117827 A1
(43) Pub. Date: Apr. 30, 2026

(54) POSITION ESTIMATE FOR DISCONNECT DEVICE IN DRIVELINE FOR VEHICLE

(71) Applicant: Rivian IP Holdings, LLC, Irvine, CA (US)

(72) Inventors: Aravind ARUN, Irvine, CA (US); Brian Neal HARRIES, Redondo Beach, CA (US); Shakshi HIMMATRAMKA, Irvine, CA (US); Kaushal Kumar DAROKAR, Foothill Ranch, CA (US); Udit PURI, Irvine, CA (US)

(21) Appl. No.: 19/365,600

(22) Filed: Oct. 22, 2025

Related U.S. Application Data
(60) Provisional application No. 63/713,766, filed on Oct. 30, 2024.

(51) Int. Cl. F16D 27/118; B60K 17/02; F16H 59/56; G01D 5/20

(52) U.S. Cl. CPC F16D 27/118; B60K 17/02; F16H 59/56; G01D 5/20; F16D 2300/18; F16D 2500/1022; F16D 2500/10412; F16D 2500/5012

(57) ABSTRACT

A vehicle includes a differential gear and a disconnect device configured to move between a first position in which the disconnect device is configured to engage the differential gear and a second position in which the disconnect device is configured to disengage the differential gear. The vehicle further includes a solenoid configured to move the disconnect device between the first position and the second position. The vehicle further includes one or more processors configured to estimate an inductance of the solenoid based, at least in part, on electrical operating characteristics of the solenoid. The one or more processors are further configured to estimate, based on the estimated inductance of the solenoid, a current position of the disconnect device as corresponding to the first position or the second position.

### CROSS-REFERENCE TO RELATED APPLICATION

This application claims the benefit of U.S. Provisional Ser. No. 63/713,766 filed on Oct. 30, 2024, which is assigned to the assignee hereof and are hereby expressly incorporated by reference in their entirety as if fully set forth below and for all applicable purposes.

### INTRODUCTION

The present disclosure relates to vehicles having a disconnect device and, more particularly, to techniques for estimating a current position of the disconnect device.

### SUMMARY

In one aspect, a vehicle is provided. The vehicle includes a differential gear; a disconnect device configured to move between a first position in which the disconnect device is configured to engage the differential gear and a second position in which the disconnect device is configured to disengage the differential gear; and a solenoid configured to move the disconnect device between the first position and the second position. The vehicle further includes one or more processors configured to: estimate an inductance of the solenoid based, at least in part, on electrical operating characteristics of the solenoid; and estimate, based on the estimated inductance of the solenoid, a current position of the disconnect device as corresponding to the first position or the second position.

In another aspect, a method is provided. The method includes: obtaining electrical operating characteristics of a solenoid configured to move the disconnect device between a first position in which the disconnect device engages a differential gear of the vehicle and a second position in which the disconnect device is disengaged from the differential gear; estimate an inductance of the solenoid based, at least in part, on the electrical operating characteristics of the solenoid; and estimate the current position of the disconnect device as corresponding to one of the first position or the second position.

In yet another aspect, a computing system is provided. The computing system includes one or more memories having processor-executable instructions and one or more processors coupled to the one or more memories and configured to execute the processor-executable instructions and cause the computing system to perform the above-described method.

Without limiting the scope of the present embodiments, their more prominent features will now be discussed below. After considering this discussion, and particularly after reading the section entitled “Detailed Description,” one will understand how the features of the present embodiments provide the advantages described here.

### BRIEF DESCRIPTION OF THE DRAWINGS

FIG. 1A illustrates an example vehicle in accordance with certain embodiments.

FIG. 1B illustrates a chassis of a vehicle in accordance with certain embodiments.

FIG. 2A is a schematic block diagram of components of a vehicle in accordance with certain embodiments.

FIG. 2B is a schematic block diagram of alternative components of a vehicle in accordance with certain embodiments.

FIG. 3A is a disconnect device in an unlocked position in accordance with certain embodiments.

FIG. 3B is a disconnect device in a locked position in accordance with certain embodiments.

FIG. 4 is a graph illustrating an output signal of a Hall effect sensor as a function of an input current to a solenoid when a disconnect device is in an unlocked position in accordance with certain embodiments.

FIG. 5A is a disconnect device and a differential gear spline blocked in accordance with certain embodiments.

FIG. 5B is a disconnect device partially locked with a differential gear in accordance with certain embodiments.

FIG. 5C is a disconnect device locked with a differential gear in accordance with certain embodiments.

FIG. 6A is a graph illustrating a position signal indicating state changes for a disconnect device in accordance with certain embodiments.

FIG. 6B is a graph illustrating an output signal of a position sensor indicating an estimated state of a disconnect device versus an output signal of a ground truth sensor indicating an actual state of the disconnect device in accordance with certain embodiments.

FIG. 6C is a graph illustrating an input current provided to a solenoid in accordance with certain embodiments.

FIG. 7A is a graph illustrating a position signal indicating state changes for a disconnect device in accordance with certain embodiments.

FIG. 7B is a graph illustrating an output signal of a position sensor indicating an estimated state of a disconnect device versus an output signal of a ground truth sensor indicating an actual state of the disconnect device in accordance with certain embodiments.

FIG. 7C is a graph illustrating an input current provided to a solenoid in accordance with certain embodiments.

FIG. 7D is a graph illustrating an input current provided to a solenoid in accordance with certain embodiments.

FIG. 7E is a graph illustrating a voltage provided to a solenoid in accordance with certain embodiments.

FIG. 7F is a graph illustrating an output signal of a position sensor indicating an estimated state of a disconnect device versus an output signal of a ground truth sensor indicating an actual state of the disconnect device in accordance with certain embodiments.

FIG. 7G is a graph illustrating an inductance of a solenoid in accordance with certain embodiments.

FIG. 8 depicts inputs and output(s) for a machine learning model configured to determine a current position of a disconnect device in accordance with certain embodiments.

FIG. 9 depicts a graph illustrating an output signal associated with output generated by a machine learning model and indicating a current position of a disconnect device and an output signal generated by a ground truth sensor and also indicating the current position of the disconnect device in accordance with certain embodiments.

FIG. 10 depicts a block diagram of a portion of a drive axle of a vehicle in accordance with certain embodiments.

FIG. 11 depicts a method for estimating a current position of a disconnect device in accordance with certain embodiments.

### DETAILED DESCRIPTION

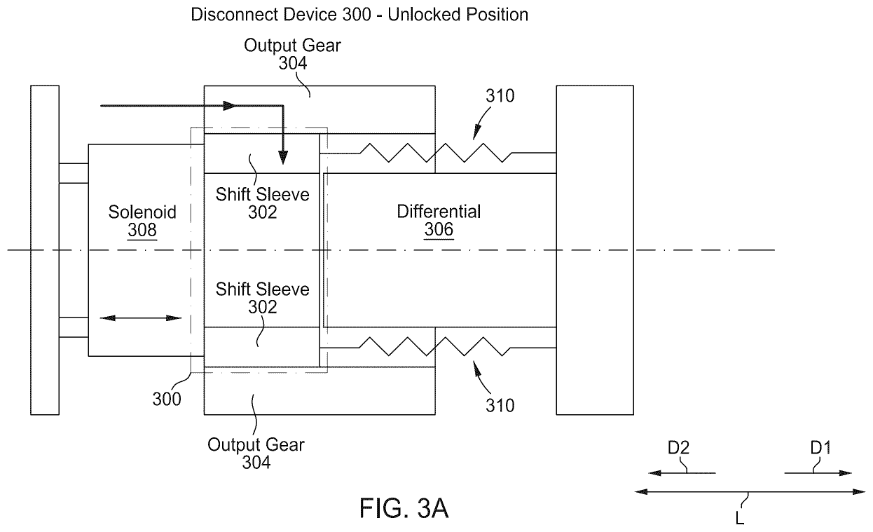

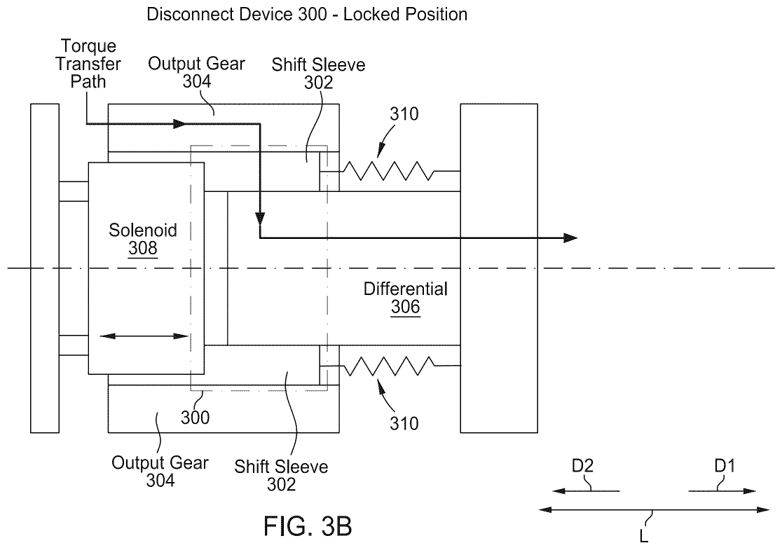

Example aspects of the present disclosure are directed to a disconnect device for selectively coupling a power source (e.g., electric motor) on a vehicle to a load (e.g., wheels) on the vehicle. As will be discussed with reference to FIGS. 3A and 3B, the disconnect device (e.g., a shift sleeve) may include splines that engage (e.g., mesh with) splines of an output gear (e.g., differential gear) that is coupled to a motor of the vehicle. The disconnect device may be movable from an unlocked position (e.g., illustrated in FIG. 3A) to a locked position (e.g., illustrated in FIG. 3B) and vice versa. In the unlocked position, the splines of the disconnect device do not engage the splines of the output gear. In the locked position, the splines of the disconnect device do engage the splines of the output gear.

To move the disconnect device to the locked position, a solenoid may be activated (e.g., by applying an input current thereto) to move (e.g., push in a first direction) the disconnect device along a lateral axis until the splines of the disconnect device engage the splines of the output gear. To return the disconnect device to the unlocked position, the solenoid may be deactivated (e.g., by no longer applying the input current thereto) and a return spring may move (e.g., push in a second direction that is opposite the first direction) the disconnect device along the lateral axis to the unlocked position.

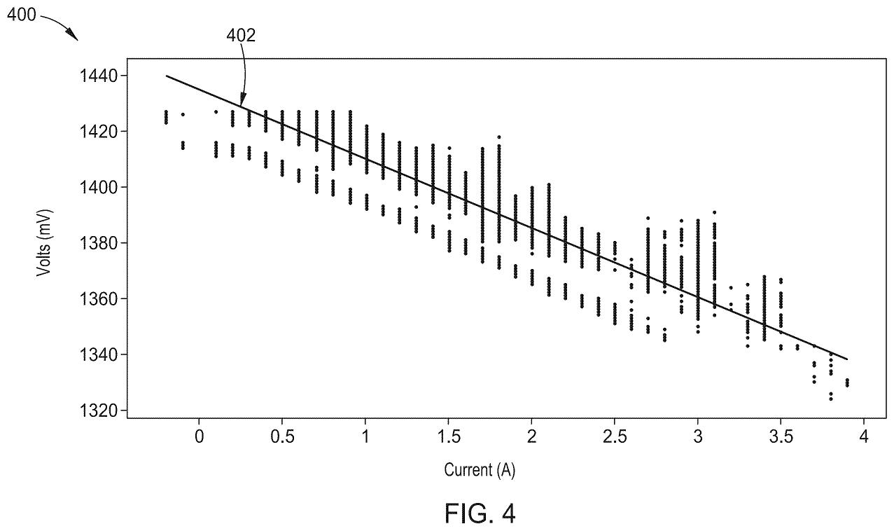

Existing vehicles may include a position sensor configured to determine a position (e.g., unlocked position, locked position) of the disconnect device. The position sensor typically includes a Hall effect sensor that determines the position of the disconnect device based on proximity of the Hall effect sensor to a target plate that can be connected to the disconnect device or the solenoid. However, as will be discussed with reference to FIG. 4, the output signal of the Hall effect sensor may be affected due to electromagnetic interference (EMI) between the Hall effect sensor and the solenoid.

The EMI between the solenoid and the Hall effect sensor may cause the output signal of the Hall effect sensor to be inaccurate. For example, the output signal of the Hall effect sensor may incorrectly indicate that the disconnect device is in the locked position when the disconnect device is actually in an intermediate position (hereinafter, referred to as a “partially locked” position) in which the splines of the disconnect device only partially engage (e.g., are in partial mesh) with the splines of the differential gear. This inaccuracy in the output signal of the Hall effect sensor can, in some instances, cause the disconnect device to be damaged. For example, the disconnect device may be damaged if the motor applies torque to the wheels when the output signal of the position sensor incorrectly indicates the disconnect device is in the locked position when the disconnect device is actually in the partially locked position. More specifically, one or more splines of the disconnect device that contact (and do not overlap to the specified minimum overlap length) with the splines of the differential gear when the shift sleeve is in the partially locked position may be damaged.

Example aspects of the present disclosure are directed to techniques for determining a state of the disconnect device that addresses the above-mentioned challenges associated with existing approaches that utilize a position sensor (e.g., Hall effect sensor). For example, the disclosed techniques may include a machine learning based approach in which one or more parameters (e.g., current, voltage, load torque, estimated inductance) are provided as input features to a machine learning model (e.g., a neural network) trained to process the parameter(s) and output a current position (e.g., one of unlocked, partially locked, and locked) of the disconnect device.

In some embodiments, an input signal (e.g., current signal) for the solenoid may be one of the input features to the machine learning model. For example, each time the input signal is applied to the solenoid, the solenoid may generate a back electromotive force (EMF) that appears as a ripple in the input signal. The ripple in the input signal can be an indicator of the disconnect device moving. More specifically, movement of the disconnect device from the partially locked position to the locked position may be determined based on characteristics of the ripple in the input signal.

In some embodiments, a load torque signal may be one of the input features to the machine learning model. For example, the load torque signal may correspond to a difference in the load acceleration (e.g., wheels of the vehicle) when the disconnect device is engaged versus when the disconnect device is disengaged. In this manner, the load torque signal may be used by the machine learning model to more accurately determine when the disconnect device transitions from the partially locked position to the locked position.

In some embodiments, the disclosed techniques may include determining a position of the disconnect device based, at least in part, on a position of the solenoid. For example, the solenoid may be in a first position when the disconnect device is in the unlocked position, a second position when the disconnect device is in the partially locked position, and a third position when the disconnect device is in the locked position. Furthermore, the solenoid may have a different inductance at each of these positions (e.g., first, second, and third positions). In this manner, the disclosed techniques may include determining the position of the disconnect device based, at least in part, on an estimated inductance of the solenoid. For example, the inductance of the solenoid may be estimated based, at least in part, on a current and a voltage applied to the solenoid. In some embodiments, a filter (e.g., Kalman filter) may output the estimated inductance of the solenoid based, at least in part, on a measured current and measured voltage associated with the solenoid. Furthermore, based on the estimated inductance of the solenoid, the solenoid may be determined to be in one of the first, second, or third positions. And, based on the determined position of the solenoid, the current position of the disconnect device may be determined to be unlocked, partially locked, or locked.

Example aspects of the present disclosure provide numerous technical effects and benefits. For example, by using multiple parameters (e.g., current, voltage, and load torque) to determine a current position (e.g., unlocked, partially locked, or locked) of the disconnect device, the disclosed techniques can more accurately track the current position of the disconnect device compared to existing approaches that rely on a single parameter (that is, the output of a Hall effect sensor) to track the current position of the disconnect device. With this improved accuracy in tracking the current position of the disconnect device, the disclosed techniques can eliminate (or at least reduce) the likelihood of the disconnect device being damaged due to, for example, torque being applied to the wheels when the current position of the disconnect device is incorrectly estimated to be in the locked position when the disconnect device is actually in the partially locked position.

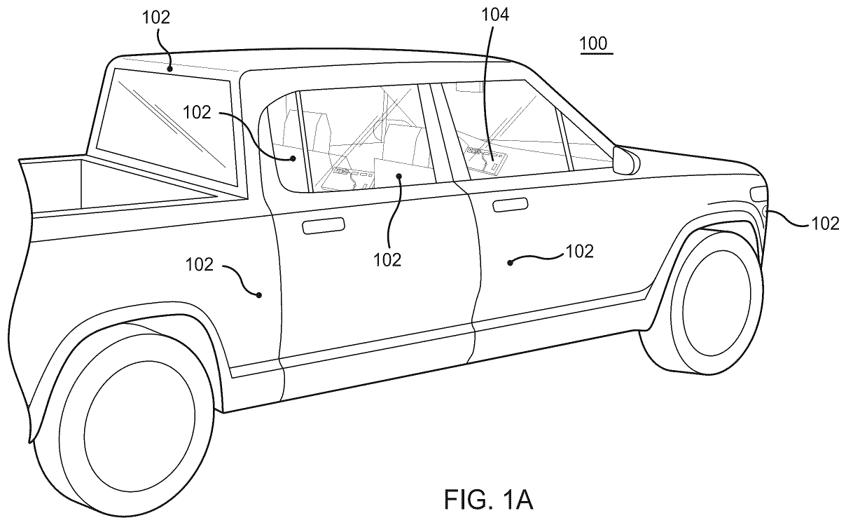

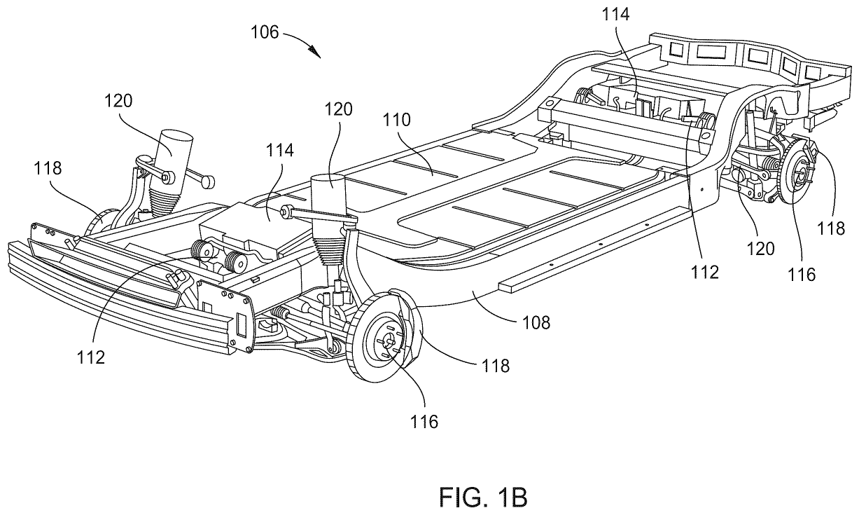

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear reduction drive. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power electronics 114. The power electronics 114 may include inverters configured to convert direct current (DC) from the battery 110 into alternating current (AC) supplied to the motors of the drive units 112.

The drive units 112 are coupled to two or more hubs 116 to which wheels may mount. Each hub 116 includes a corresponding brake 118, such as the illustrated disc brakes. The drive units 112 or other component may also provide regenerative braking. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIGS. 1B and 1n the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that requires heating in preparation for use, such as diesel engines.

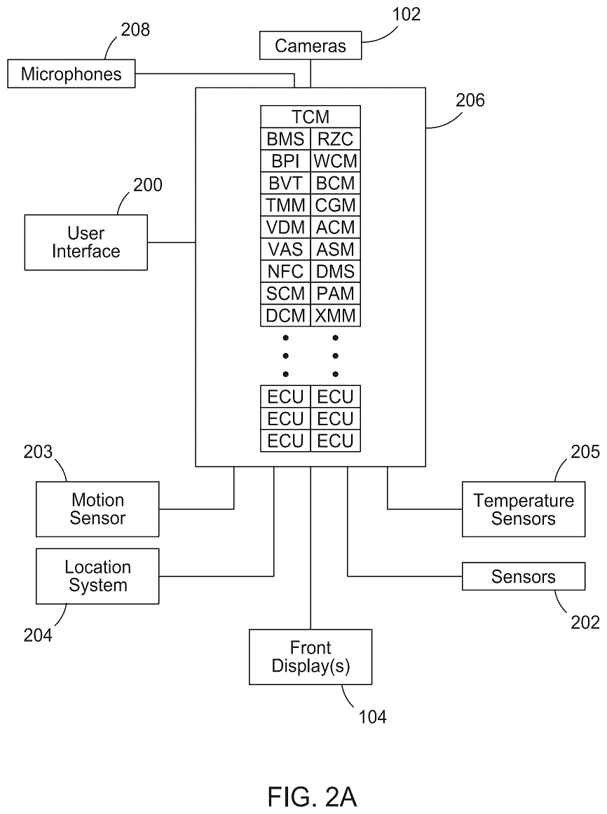

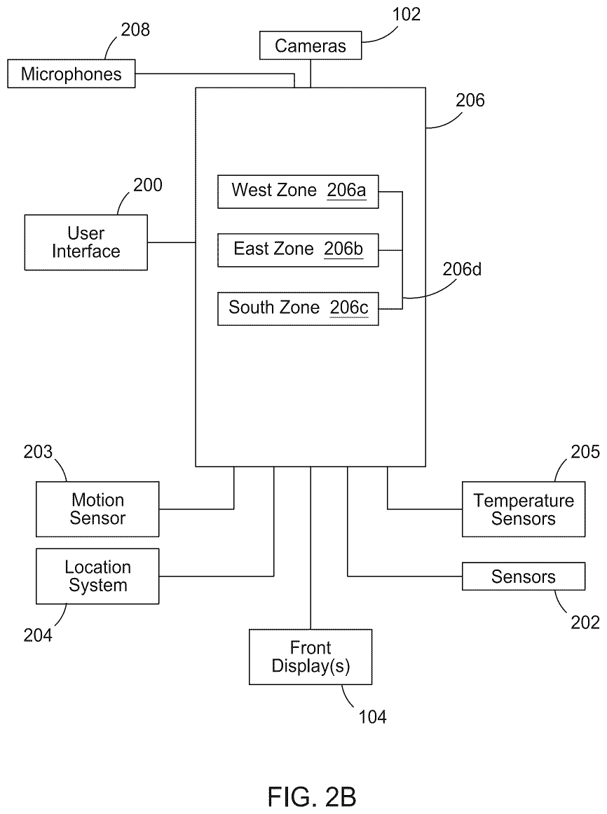

FIG. 2A illustrates example components of the vehicle 100 of FIG. 1A. As shown in FIG. 2A, the vehicle 100 includes the cameras 102, the one or more front displays 104, a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The location system 204 may be implemented as a global positioning system (GPS) receiver. The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of power electronics 114, temperature of each drive unit 112 and/or each motor of each drive unit 112, or the temperature of any other component of the vehicle 100.

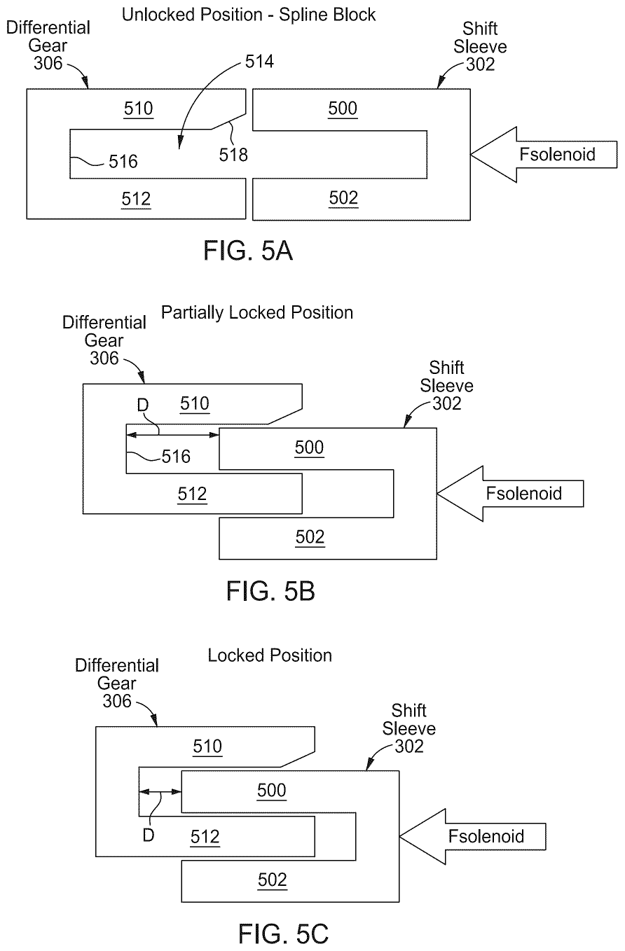

A control system 206 executes instructions to perform at least some of the actions or functions of the vehicle 100, including the functions described in relation to FIGS. 4 and 5. For example, as shown in FIG. 2A, the control system 206 may include one or more electronic control units (ECUs) configured to perform at least some of the actions or functions of the vehicle 100. In certain embodiments, each of the ECUs is dedicated to a specific set of functions. Furthermore, in some embodiments, each ECU may be a computer system.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102 and sensors 202. The sensor signals collected by the CGM ECU are then communicated to the appropriate ECUs for performing, for example, the operations and functions described in relation to FIGS. 3 to 5.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an east zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal performing the functions of the ECU for the portion of the vehicle to which that zonal controller 206a, 206b, 206c is assigned.

The zonal controllers 206a, 206b, 206c may be connected to one another by a network 206d, such as an Ethernet network, controller area network (CAN), or other type of network.

FIG. 3A and FIG. 3B depict a disconnect device 300 for a vehicle in accordance with certain embodiments of the present disclosure. The disconnect device 300 may, for example, be implemented in the vehicle 100 discussed above with reference to FIG. 1A. FIG. 3A depicts the disconnect device 300 in an unlocked position, whereas FIG. 3B depicts the disconnect device 300 in a locked position.

In some embodiments, the disconnect device 300 may be a shift sleeve 302 having splines (not shown). The splines of the shift sleeve 302 may engage splines (not shown) of an output gear 304 that, in some embodiments, may be coupled to a motor (not shown) of the vehicle.

The shift sleeve 302 may be movable from an unlocked position (e.g., illustrated in FIG. 3A) to a locked position (e.g., illustrated in FIG. 3B) and vice versa. In the unlocked position, the splines of the shift sleeve 302 do not engage splines (not shown) of a differential gear 306 that is coupled to wheels (not shown) of the vehicle. In the locked position, however, the splines of the shift sleeve 302 do engage the splines (not shown) of the differential gear 306.

To move the shift sleeve 302 to the locked position, a solenoid 308 may be activated (e.g., by applying an input current thereto) to move (e.g., push in a first direction D1) the shift sleeve 302 along a lateral axis L until the splines of the shift sleeve 302 engage the splines of the differential gear 306. To return the shift sleeve 302 to the unlocked position, the solenoid 308 may be deactivated (e.g., by no longer applying the input current thereto) and a return spring 310 may move (e.g., push in a second direction D2 that is opposite the first direction D1) the shift sleeve 302 along the lateral axis L to return the shift sleeve 302 to the unlocked position.

FIG. 4 is a graph 400 illustrating the effect a current signal provided to a solenoid has on the output signal of a position sensor (e.g., Hall effect) configured to sense a position of a disconnect device in accordance with certain embodiments. More specifically, the graph 400 illustrates the effect that the current signal has on the output signal while the disconnect device is unlocked.

The graph 400 includes line 402 to illustrate that the voltage (e.g., denoted along the vertical axis in millivolts) of the output signal of the position sensor decreases as the amplitude of an input signal (e.g., current) for the solenoid is increased. The decreasing value (e.g., voltage) of the output signal of the position sensor when the disconnect device is held in the unlocked position is incorrect and illustrates the effect that EMI between the solenoid and the position sensor has on the output signal of the position sensor.

FIGS. 5A-5C illustrate different arrangements of splines 500, 502 of the shift sleeve 302 relative to splines 510, 512 of the differential gear 306 in accordance with certain embodiments. In particular, FIG. 5A depicts the shift sleeve 302 in an unlocked position; FIG. 5B depicts the shift sleeve 302 in a partially locked position; and FIG. 5C depicts the shift sleeve 302 in a locked position.

In FIG. 5A, the splines 500, 502 of the shift sleeve 302 are not engaged (e.g., in mesh) with the splines 510, 512 of the differential gear 306. Furthermore, the shift sleeve 302 is shown rotated relative to the differential gear 306 such that that spline 500 of the shift sleeve 302 is in line with spline 510 of the differential gear 306 and spline 502 of the shift sleeve 302 is in line with spline 512 of the different gear 306. This particular alignment of the splines 500, 502 of the shift sleeve 302 with the splines 510, 512 of the differential gear 306 may be referred to as spline block. And, when spline block exists, a force, F_{solenoid}, applied to the shift sleeve 302 to move the shift sleeve 302 from the unlocked position does not cause the shift sleeve 302 to move to the partially locked position shown in FIG. 5B. To resolve spline block, the shift sleeve 302 may be rotated relative to the differential gear 306 such that spline 500 of the shift sleeve 302 is no longer in line with spline 510 of the differential gear 306. Once rotated, the force, F_{solenoid}, may be applied to move the shift sleeve 302 to the partially locked position illustrated in FIG. 5B.

In FIG. 5B, spline 500 of the shift sleeve 302 is partially positioned within a channel 514 defined between spline 510 of the differential gear 306 and spline 512 of the differential gear 306. As illustrated, more of the spline 500 of the shift sleeve 302 is positioned outside of the channel 514 than in the channel 514. Thus, the spline 500 of the shift sleeve 302 only partially engages splines 510, 512 of the differential gear 306. To move the shift sleeve 302 to the locked position illustrated in FIG. 5C, the solenoid continues to apply the force, F_{solenoid}, to the shift sleeve 302 to move the spline 500 of the shift sleeve 302 further into the channel 514 of the of the differential gear 306 to reduce a distance D between the spline 500 of the shift sleeve 302 and a bottom 516 of the channel 514.

In some embodiments, spline 510 of the differential gear 306 may have a chamfer portion 518, as shown in FIG. 5A. The chamfer portion 518 of spline 510 may allow a spline (e.g., spline 500) of the shift sleeve 302 to slide into the channel 514 defined between splines 510, 512 of the differential gear 306 and, in doing so, engage splines 510, 512 of the differential gear 306. The speed at which the shift sleeve 302 is rotating relative to the differential gear 306 may cause the splines 500, 502 of the shift sleeve 302 to ratchet (e.g., move in and out of spline engagement with respect to splines 510, 512 of the differential gear 306).

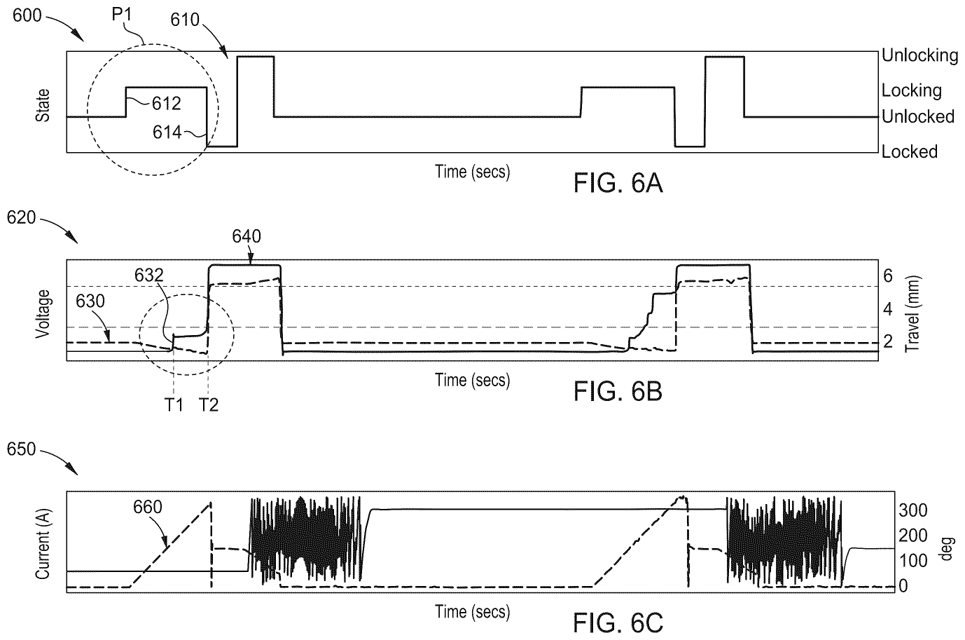

FIGS. 6A-6C depict different signals illustrating changes in position (e.g., unlocked to partially locked, partially locked to locked, locked to partially unlocked, and partially unlocked to unlocked) of a disconnect device according to some embodiments of the present disclosure.

FIG. 6A depicts a graph 600 illustrating a signal 610 indicative of movement of the disconnect device according to some embodiments of the present disclosure. The signal 610 includes multiple pluses (e.g., each defined by a rising edge and a falling edge). For example, a first pulse P1 of the signal 610 represents the disconnect device transitioning from the unlocked position to the locked position. The first pulse P1 includes rising edge 612, which represents the start of actuation and is indicative of the disconnect device moving from an unlocked position (e.g., shown in FIG. 5A) to a partially locked position (e.g., shown in FIG. 5B). The first pulse P1 of the signal 610 may also include a falling edge 614, which represents the end of actuation and is indicative of the disconnect device moving from the partially locked position to the locked position (e.g., shown in FIG. 5C).

FIG. 6B depicts a graph 620 illustrating an output signal 630 of a position sensor (e.g., Hall effect) versus an output signal 640 of a ground truth sensor (e.g., not affected by additional magnetic field generated by supply current to solenoid) according to some embodiments of the present disclosure. The output signal 630 of the position sensor may represent an estimated position (e.g., unlocked, partially locked, or locked) of the disconnect device as measured by the position sensor, whereas the output signal 640 of the ground truth sensor may represent an actual position of the disconnect device as measured by the ground truth sensor.

FIG. 6C depicts a graph 650 illustrating a current signal 660 provided to a solenoid (e.g., the solenoid 308 in FIG. 3A and FIG. 3B) according to certain embodiments of the present disclosure. Referring now to FIGS. 6B and 6C, the solenoid may be blocked at time T1 when the solenoid initially attempts to move the disconnect device. More specifically, at time T1, the splines of the disconnect device may be in line with the splines of the differential gear as discussed above with reference to FIG. 6A. In this manner, the solenoid may be blocked from moving (e.g., pushing) the disconnect device to engage (e.g., mesh) the splines of the disconnect device engage with the splines of the differential gear.

The ground truth sensor senses this event (that is, spline block) as indicated by rising edge 632 of the output signal 640 at time T1. The output signal 630 of the position sensor, however, does not exhibit this same behavior at time T1. Instead, as illustrated, the output signal 630 of the position sensor continues decreasing at time T1. Therefore, FIG. 6B illustrates that relying on the output signal 630 of the position sensor only at time T1 incorrectly indicates that the position sensor is backing out, which is not possible given the actual state of the disconnect device (e.g., as indicated by the output signal 640 of the ground truth sensor) at time T1.

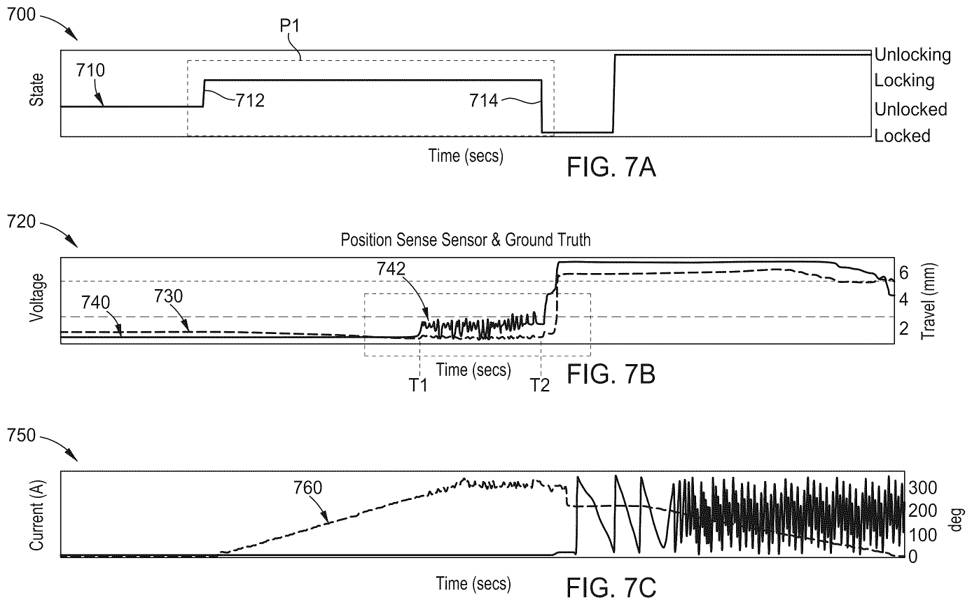

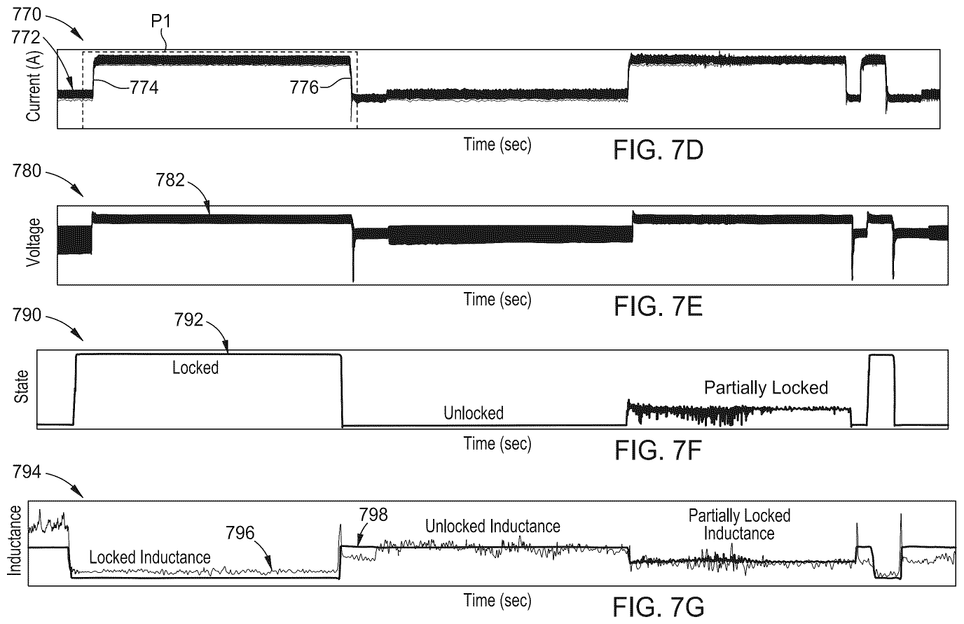

FIGS. 7A-7C depict different signals illustrating state transitions (e.g., between locked and unlocked) of a disconnect device according to some embodiments of the present disclosure.

FIG. 7A depicts a graph 700 illustrating a signal 710 indicative of movement of the disconnect device according to some embodiments of the present disclosure. The signal 710 includes multiple pluses (e.g., each defined by a rising edge and a falling edge). For example, a first pulse P1 of the signal 710 may including rising edge 712 indicative of the disconnect device moving from an unlocked position (e.g., shown in FIG. 5A) to a partially locked position (e.g., shown in FIG. 5B). The first pulse P1 of the signal 710 may also include a falling edge 714 indicative of the disconnect device moving from the partially locked position to the locked position (e.g., shown in FIG. 5C).

FIG. 7B depicts a graph 720 illustrating an output signal 730 of a position sensor (e.g., Hall effect sensor) versus an output signal 740 of a ground truth sensor (e.g., not affected by additional magnetic field generated by supply current to solenoid) according to some embodiments of the present disclosure. The output signal 730 of the position sensor may represent an estimated position (e.g., unlocked, partially locked, or locked) of the disconnect device as measured by the position sensor, whereas the output signal 740 of the ground truth sensor may represent an actual position of the disconnect device.

FIG. 7C depicts a graph 750 illustrating a current signal 760 (e.g., indicative of an operating current) provided to a solenoid according to some embodiments of the present disclosure. Referring now to FIG. 7B and FIG. 7C, the disconnect device may be rotating too fast relative to the differential gear from time T1 to time T2 and, as a result, the disconnect device may ratchet (that is, move in and out of spline engagement with the differential gear). This behavior is indicated in the output signal 740 of the ground truth sensor as multiple oscillations 742 (e.g., noise). These oscillations can also be seen in the output signal 730 of the position sensor. However, the amplitude of these oscillations in the output signal 730 is smaller due to the effect of the input signal (e.g., current signal 760) for the solenoid on the output signal 730 (e.g., voltage signal) of the position sensor.

FIGS. 7D-7G also depict different signals illustrating state transitions (e.g., between locked and unlocked) of the disconnect device according to some embodiments of the present disclosure.

FIG. 7D depicts a graph 770 illustrating a current signal 772 indicative of movement of the disconnect device according to some embodiments of the present disclosure. The current signal 772 includes multiple pluses (e.g., each defined by a rising edge and a falling edge). For example, a first pulse P1 of the current signal 772 may include rising edge 774 indicative of the disconnect device moving from an unlocked position (e.g., shown in FIG. 5A) to a locked position (e.g., shown in FIG. 5C). The first pulse P1 of the current signal 772 may also include a falling edge 776 indicative of the disconnect device moving from the locked position to the unlocked position (e.g., shown in FIG. 5A).

In contrast to the signal 710 of FIG. 7A, the current signal 772 of FIG. 7D may include one or more ripples (e.g., indicated by oscillations in current signal 772) that allows inductance to be more accurately determined. In various embodiments, the ripple(s) may be added to the current signal 772 to improve the ability of the ECU, for example, the filter (e.g., Kalman filter) thereof, to estimate the inductance of the solenoid.

FIG. 7E depicts a graph 780 illustrating a voltage signal 782 indicative of movement of the disconnect device according to some embodiments of the present disclosure. The voltage signal 782 may be indicative of an operating voltage for the solenoid associated with operation of the solenoid. For instance, the operating voltage of the solenoid may vary as the disconnect device moves between the unlocked, partially locked, and locked positions.

Similar to the current signal 772 of FIG. 7D, the voltage signal 782 of FIG. 7E may include one or more ripples (e.g., indicated by oscillations in voltage signal 782) that allows inductance to be more apparent. It should be appreciated that the ripple(s) may be added to the voltage signal 782 to improve estimation of the inductance of the solenoid.

FIG. 7F depicts a graph 790 illustrating an output signal 792 of a position sensor (e.g., Hall effect sensor) according to some embodiments of the present disclosure. The output signal 792 of the position sensor may represent an estimated position (e.g., unlocked, partially locked, or locked) of the disconnect device as measured by the position sensor.

FIG. 7G depicts a graph 794 illustrating a first signal 796 indicative of an estimated inductance of the solenoid and a second signal 798 indicative of an actual inductance of the solenoid according to certain embodiments. In particular, the graph 794 illustrates how the estimated inductance (e.g., indicated by first signal 796) of the solenoid closely matches the actual inductance (e.g., indicated by second signal 798). It should be appreciated that the improved accuracy in estimating the inductance of the solenoid may be due, at least in part, to the ripple(s) that are added to the current signal 772 and the voltage signal 782 associated with the solenoid and which are inputs to the filter (e.g., Kalman) that is configured to estimate the inductance of the solenoid.

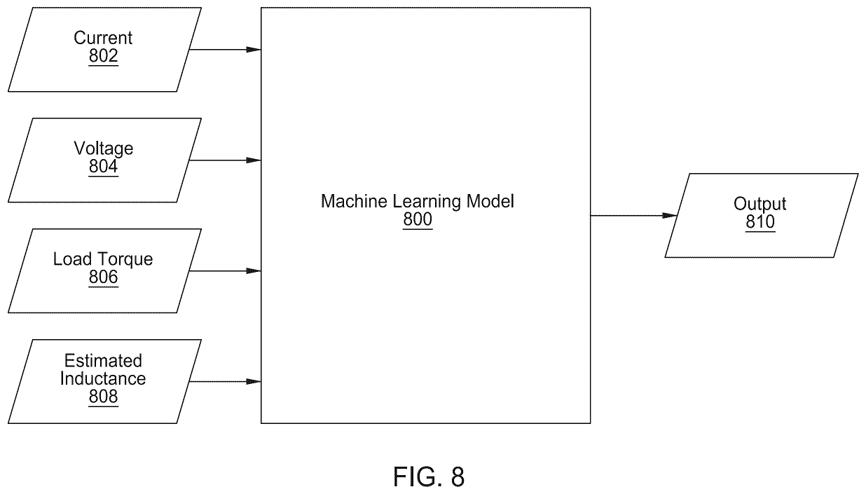

FIG. 8 depicts inputs and output of a machine learning model 800 trained to estimate a current position of a disconnect device in accordance with certain embodiments. As shown, input features for the machine learning model 800 may include one or more of current 802, voltage 804, and load torque 806. The current 802 may correspond to a current provided to the solenoid to move the disconnect device from the unlocked position to the partially locked position and ultimately the locked position. The voltage 804 may correspond to a voltage associated with the solenoid. Furthermore, in some embodiments, an additional input feature for the machine learning model 800 may be determined based, at least in part, on the current 802 and the voltage 804. For example, an inductance of the solenoid may be estimated (e.g., using a filter, such as a Kalman filter) based on the current 802 and the voltage 804.

In some embodiments, the input features for the machine learning model 800 may include the load torque 806, which may include one or more signals indicative of the torque applied to the wheels of the vehicle. Furthermore, the load torque 806 may be used by the machine learning model 800 to determine when the disconnect device is in the locked position. In some embodiments, the input features for the machine learning model 800 may additionally include the output signal from the position sensor (e.g., Hall effect sensor).

In some embodiments, the input features for the machine learning model 800 may include an estimated inductance 808 of the solenoid. For instance, the estimated inductance 808 may be output by the ECM, such as the filter thereof, and may be provided as one of the input features for the machine learning model 800.

The machine learning model 800 may be configured to process the input features and generate an output 810 indicative of a current position of the disconnect device. For example, the machine learning model 800 may be configured to process the input feature(s) to classify the current position of the disconnect device as one of: unlocked; partially locked; or locked. Thus, the output 810 of the machine learning model 800 may indicate that the current position of the disconnect device corresponds to one of the above-mentioned positions in FIGS. 5A-5C.

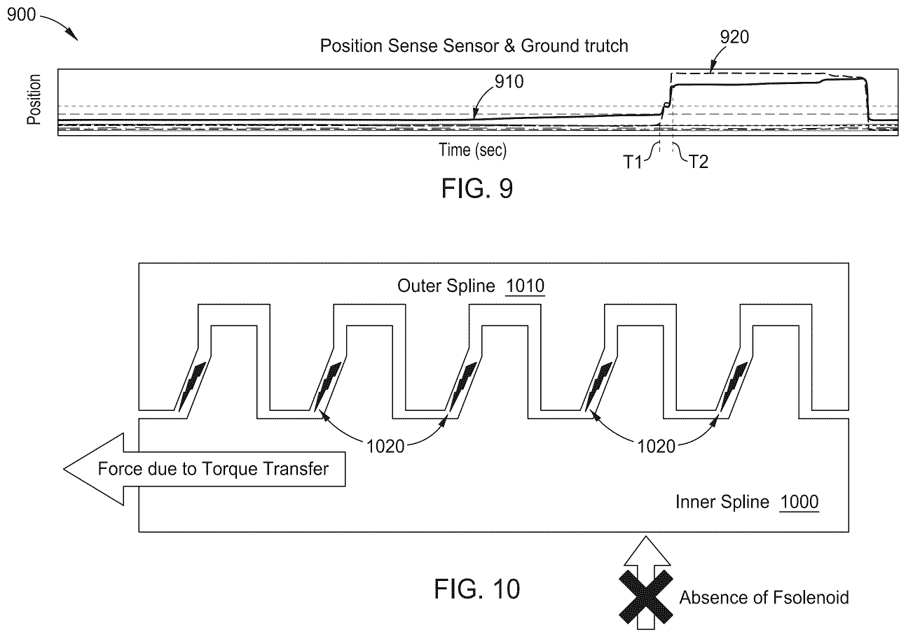

FIG. 9 depicts a graph 900 illustrating an output signal 910 associated with the output of the machine learning model versus an output signal 920 of a ground truth sensor (e.g., not affected by additional magnetic field generated by supply current to solenoid) according to some embodiments of the present disclosure. The output signal 910 associated with the machine learning model may represent an estimated position (e.g., unlocked, partially locked, or locked) of the disconnect device as estimated based on the input features (e.g., current, voltage, load torque) provided to the machine learning model, whereas the output signal 920 of the ground truth sensor may represent an actual position of the disconnect device.

As illustrated, the output signal 910 associated with the output of the machine learning model closely tracks the output signal 920 of the ground truth sensor. For example, the output signal 910 associated with the output of the machine learning model more closely matches the output signal 920 of the ground truth sensor when the disconnect device is transitioning from the unlocked position to the partially locked position and then from the partially locked position to the locked position. In this manner, the machine learning based approach for estimating the current position of the disconnect device is improved (e.g., more accurate) compared to the existing sensor-based approach (e.g., using Hall effect sensors).

FIG. 10 depicts a block diagram of a portion of a drive axle of a vehicle according to certain embodiments. As shown, an inner spline 1000 engages an outer spline 1010 to transfer torque a load of the vehicle, such as wheels (e.g., rear wheels) coupled to the drive axle. In some embodiments, the inner spline 1000 may correspond to the disconnect device 300 discussed above with reference to FIGS. 3A and 3B, and the outer spline 1010 may correspond to the differential gear 306 discussed above with reference to FIGS. 3A and 3B.

As discussed above, a current may be provided to a solenoid (e.g., solenoid 308 in FIGS. 3A and 3B) to apply a force, F_{solenoid}, to push the disconnect device to engage the differential gear. With the disconnect device engaged with the differential gear, the motor may then apply torque to the drive axle to rotate the wheels. Example aspects of the present disclosure are directed to applying a threshold amount of torque to the drive axle to keep the disconnect device (e.g., inner spline 1000) engaged with the differential gear (e.g., outer spline). More specifically, applying the threshold amount of torque may introduce a frictional force 1020 between the disconnect device and the differential gear that, in effect, prevents the disconnect device from disengaging the differential gear. In this manner, the disclosed techniques may, for example, eliminate the need for the solenoid to continue to apply the force, F_{solenoid}, after the disconnect device initially engages the differential gear and the motor begins applying the threshold amount of torque to the drive axle. In this manner, the disclosed techniques may provide power savings (e.g, reduced run time of solenoid) that may extend the life of batteries on the vehicle and, as a result, may extend the range (that is, distance traveled between charging the batteries) of the vehicle.

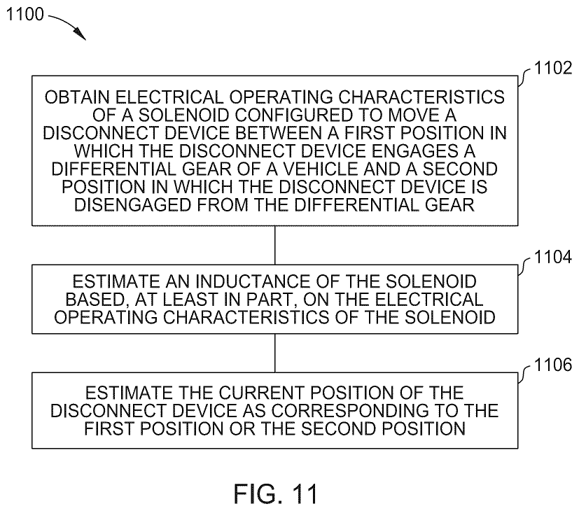

FIG. 11 depicts a method 1100 for estimating a current position of a disconnect device of a vehicle according to some embodiments of the present disclosure. In some embodiments, one or more steps of the method 1100 may be performed by an ECU onboard the vehicle.

At 1102, the method 1100 includes obtaining, by one or more processors, electrical operating characteristics of a solenoid configured to move the disconnect device between a first position in which the disconnect device engages a differential gear of the vehicle and a second position in which the disconnect device is disengaged from the differential gear.

At 1104, the method 1100 includes estimating, by one or more processors, an inductance of the solenoid based, at least in part, on the electrical operating characteristics of the solenoid. In some embodiments, estimating the inductance comprises providing, by one or more processors, a current signal and a voltage signal as an input to a filter (e.g., included in an ECU), and obtaining the estimated inductance of the solenoid as an output of the filter.

At 1106, the method 1100 includes estimating the current position of the disconnect device as corresponding to one of the first position or the second position.

In some embodiments, estimating the current position of the disconnect device includes providing one or more input features to a machine learning model configured to classify the current position of the disconnect device. For instance, the one or more input features may include estimated inductance of the solenoid. Furthermore, estimating the current position of the disconnect device may include obtaining an output of the machine learning model, the output classifying the current position of the disconnect device as one of the first position, the second position. In some embodiments, the machine learning model may be further configured to classify the current position of the disconnect device as corresponding to a third position in which the disconnect device partially engages the differential gear.

In some embodiments, the one or more input features may further include the current signal and the voltage signal. Furthermore, in some embodiments, the one or more input features may further include a load torque signal that is indicative of whether the disconnect device is in the first position or the second position.

In some embodiments, the method 1100 may further include, responsive to estimating the current position of the disconnect device as corresponding to the first position, applying a threshold amount of torque to a drive axle of the vehicle to prevent the disconnect device from disengaging the differential gear. Furthermore, the operations may include modifying operation of the solenoid while the threshold amount of torque is applied to the drive axle of the vehicle.

In some embodiments, modifying operating of the solenoid may include deactivating (e.g., powering off) the solenoid. For instance, in some embodiments, deactivating the solenoid may include switching from operating the solenoid in a first power state (e.g., active power state) to operating the solenoid in a second power state. It should be appreciated that the solenoid may consume less electrical power (e.g., or none) in the second power state than in the first power state.

In some embodiments, the electrical operating characteristics may include a current signal and a voltage signal. Furthermore, in some embodiments, estimating the inductance of the solenoid may include introducing one or more ripples in at least one of the current signal or the voltage signal and estimating the inductance based, at least in part, on the one or more ripples included in at least one of the current signal or the voltage signal.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely Illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

What is claimed is:

1. A vehicle comprising:
a differential gear;
a disconnect device configured to move between a first position in which the disconnect device is configured to engage the differential gear and a second position in which the disconnect device is configured to disengage the differential gear; and
a solenoid configured to move the disconnect device between the first position and the second position; and
one or more processors configured to:
estimate an inductance of the solenoid based, at least in part, on electrical operating characteristics of the solenoid; and
estimate, based on the estimated inductance of the solenoid, a current position of the disconnect device as corresponding to the first position or the second position.

2. The vehicle of claim 1, wherein the electrical operating characteristics include a current signal indicative of an operating current of the solenoid and a voltage signal indicative of an operating voltage of the solenoid.

3. The vehicle of claim 2, wherein to estimate the inductance of the solenoid, the one or more processors are configured to:
provide the current signal and the voltage signal as an input to a filter; and
obtain estimated inductance of the solenoid as an output of the filter.

4. The vehicle of claim 2, wherein to estimate the current position of the disconnect device, the one or more processors are configured to:
provide one or more input features to a machine learning model configured to classify the current position of the disconnect device, the one or more input features comprising the estimated inductance of the solenoid; and
obtain an output classifying the current position of the disconnect device as one of the first position, the second position.

5. The vehicle of claim 4, wherein the machine learning model is further configured to classify the current position of the disconnect device as corresponding to a third position in which the disconnect device partially engages the differential gear.

6. The vehicle of claim 4, wherein the one or more input features further comprise the current signal and the voltage signal.

7. The vehicle of claim 6, wherein the one or more input features further comprise a load torque signal that is indicative of whether the disconnect device is in the first position or the second position.

8. The vehicle of claim 1, wherein when the current position is estimated to be the first position, the one or more processors are further configured to:
apply a threshold amount of torque to a drive axle of the vehicle to prevent the disconnect device from disengaging the differential gear; and
modify operation of the solenoid while the threshold amount of torque is applied to the drive axle of the vehicle.

9. The vehicle of claim 8, wherein to modify operation of the solenoid, the one or more processors are configured to deactivate the solenoid.

10. The vehicle of claim 1, wherein the electrical operating characteristics comprise a current signal and a voltage signal, and wherein the one or more processors are configured to:
introduce one or more ripples in at least one of the current signal or the voltage signal; and
estimate the inductance based, at least in part, on the one or more ripples included in at least one of the current signal or the voltage signal.

11. A method of estimating a current position of a disconnect device on a vehicle, the method comprising:
obtaining, via one or more processors, electrical operating characteristics of a solenoid configured to move the disconnect device between a first position in which the disconnect device engages a differential gear of the vehicle and a second position in which the disconnect device is disengaged from the differential gear;
estimate, via the one or more processors, an inductance of the solenoid based, at least in part, on the electrical operating characteristics of the solenoid; and
estimate, via the one or more processors, the current position of the disconnect device as corresponding to the first position or the second position.

12. The method of claim 11, wherein the electrical operating characteristics comprise a current signal indicative of an operating current of the solenoid and a voltage signal indicative of an operating voltage of the solenoid.

13. The method of claim 12, wherein estimating the inductance of the solenoid comprises:
providing the current signal and the voltage signal as an input to a filter; and
obtaining the estimated inductance of the solenoid as an output of the filter.

14. The method of claim 12, wherein estimating the current position of the disconnect device comprises:
providing one or more input features to a machine learning model configured to classify the current position of the disconnect device, the one or more input features comprising the estimated inductance of the solenoid; and
obtaining an output of the machine learning model, the output classifying the current position of the disconnect device as corresponding to the first position or the second position.

15. The method of claim 14, wherein the one or more input features further comprise the current signal and the voltage signal.

16. The method of claim 15, wherein the one or more input features further comprise a load torque signal that is indicative of whether the disconnect device is in the first position or the second position.

17. The method of claim 12, further comprising:
responsive to estimating the current position of the disconnect device as corresponding to the first position, applying a threshold amount of torque to a drive axle of the vehicle to prevent the disconnect device from disengaging the differential gear; and
modifying operation of the solenoid while the threshold amount of torque is applied to the drive axle of the vehicle.

18. The method of claim 17, wherein modifying operation of the solenoid comprises deactivating the solenoid.

19. The method of claim 12, wherein the electrical operating characteristics comprise a current signal and a voltage signal, and wherein estimating the inductance of the solenoid comprises:
introducing one or more ripples in at least one of the current signal or the voltage signal; and
estimating the inductance based, at least in part, on the one or more ripples included in at least one of the current signal or the voltage signal.

20. A computing system, comprising:
one or more memories comprising processor-executable instructions; and
one or more processors coupled to the one or more memories and configured to execute the processor-executable instructions to cause the computing system to:
estimate an inductance of a solenoid configured to move a disconnect device between a first position in which the disconnect device is configured to engage a differential gear and a second position in which the disconnect device is configured to disengage the differential gear; and
estimate, based on the estimated inductance of the solenoid, a current position of the disconnect device as corresponding to the first position or the second position.
